(19) United States
(12) Patent Application Publication
(10) Pub. No.: US 2026/0200103 A1
(43) Pub. Date: Jul. 16, 2026

(54) ROBOTIC GRIPPER WITH RECONFIGURABLE FINGERS

(71) Applicants: Delta Electronics Int’l (Singapore) Pte Ltd, Singapore (SG); Nanyang Technological University, Singapore (SG)

(72) Inventors: Dino Accoto, Singapore (SG); Guo Zhan Lum, Singapore (SG); Zilin Yang, Singapore (SG); Chun-Lin Chen, Singapore (SG); Li Tian, Singapore (SG)

(21) Appl. No.: 19/326,595

(22) Filed: Sep. 11, 2025

Related U.S. Application Data
(60) Provisional application No. 63/743,774, filed on Jan. 10, 2025.

(30) Foreign Application Priority Data
Aug. 29, 2025 (SG) 10202502476Y

(51) Int. Cl. B25J 15/10; B25J 9/10; B25J 13/08; B25J 19/00

(52) U.S. Cl. CPC B25J 15/10; B25J 9/1045; B25J 13/084; B25J 19/0075

(57) ABSTRACT

A robotic gripper with reconfigurable fingers is disclosed. The trunk includes a first layer section and a second layer section arranged from top to bottom. The first rotating support portion of the first movable finger group is arranged on the first layer section, and the first bracket actuator is arranged on the first rotating support portion, and drives the first bracket to rotate. The first finger is connected to the first finger actuator at first layer section through the extension rod at the second layer section. The second rotating support portion of the second movable finger group is arranged on the second layer section. The second finger actuator is arranged on the second bracket at the second layer section. The second finger is arranged at a bottom end of the second bracket and driven by the second finger actuator. The first and second fingers are at an identical horizontal height.

### CROSS-REFERENCE TO RELATED APPLICATION

This application claims the benefit of U.S. Provisional Application No. 63/743,774 filed on Jan. 10, 2025, and entitled “ROBOT GRIPPERS WITH RECONFIGURABLE AND HYBRID SOFT-RIGID FINGERS”. This application also claims priority to Singapore Patent Application No. 10202502476Y filed on Aug. 29, 2025. The entireties of the above-mentioned patent applications are incorporated herein by reference for all purposes.

### FIELD OF THE INVENTION

The present disclosure relates to a robotic gripper, and more particularly to a robotic gripper with reconfigurable fingers for enhancing the adaptability and precision in object manipulation.

### BACKGROUND OF THE INVENTION

Robotic grippers are end-effectors that allow robots to perform grasping tasks. The performance of these robotic end-effectors is crucial in a wide range of applications, including the food industry, healthcare, smart factories, and human-robot interactions. Due to the importance of these end-effectors, a diverse range of robotic grippers has been created over the past few decades. While majority of these grippers have only one grasping configuration, the emerging reconfigurable grippers with multiple grasping configurations have attracted significant attention in the robotics community. This is because by having adaptable grasping configurations, the latter type of grippers have much higher dexterity and thus greater potential to be able to manipulate a much wider range of objects.

Existing reconfigurable grippers can be categorized based on the number of their available fingers. In the prior art, such grippers have two to four fingers. For example, Molfino et.al. had designed a gripper with two movable fingers that can readjust their positions such that the grasped object is orthogonal to them, allowing their contact surface area to be maximized. By using such strategies, the fingers can establish force closure and grasp a wide range of objects like draining pump, damper and heater. Although it is desirable to have more fingers for reconfigurable grippers, such existing end-effectors have at most four fingers. This is because it is challenging to design gripper with more than four fingers while satisfying the size constraints of their applications. In general, the grippers are constrained in terms of their maximum allowable cross-sectional area in the transverse plane because this area will dictate whether the grippers can move into tight spaces while they execute the grasping operations. Furthermore, the range of motions that existing reconfigurable grippers'fingers can achieve are limited to 120 degrees for 3 finger or 4 finger design, and this further limits their reconfigurability and overall dexterity.

Due to these reasons, existing reconfigurable grippers still have limited robustness and they are unable to handle a wide range of objects with different stiffness and geometries.

Therefore, there is a need of providing a robotic gripper with reconfigurable fingers, to enhance the adaptability and precision in object manipulation, and obviate the drawbacks encountered from the prior arts.

### SUMMARY OF THE INVENTION

It is an object of the present disclosure to provide a robotic gripper with reconfigurable fingers for enhancing the adaptability and precision in object manipulation.

It is another object of the present disclosure to provide a robotic gripper with reconfigurable fingers. The robotic gripper which is capable of adapting to a plurality of grasping configurations while ensuring that its cross-sectional area in the transverse plane is sufficiently compact for smart factory applications. The robotic gripper has for example one stationary finger and four reconfigurable fingers, which can re-position and re-orientate themselves. In order to maximize the motion range of each reconfigurable finger while concurrently minimizing their cross-sectional area in the transverse plane (x-y plane, refer to FIG. 2), the placements of the five fingers are divided into two layers with different heights (along the z-axis). Each reconfigurable finger is designed to be able to rotate ±75 degrees round the z-axis. Notably, the dimension of the robotic gripper along the z-axis is adjustable according to the practical requirements. Using the above design, the robotic gripper can potentially adapt to different configurations, making it suitable for handling objects with complex geometries and varying stiffness. Additionally, the robotic gripper is allowed to integrate various robotic fingers and soft tactile sensors, providing force and slip feedback during grasping operations.

It is a further object of the present disclosure to provide a robotic gripper with reconfigurable fingers. The robotic gripper with reconfigurable fingers offers distinct advantages in tasks that require high dexterity, adaptability, and precision. The robotic gripper with reconfigurable fingers closely mimics the human hand, allowing it to perform complex manipulation tasks such as pinching, holding, and grasping a wide range of objects. This makes the robotic gripper highly versatile for applications requiring precise control. With multiple reconfigurable fingers, the robotic gripper can adapt its shape to securely grasp objects of varying geometries, including irregular, soft, or delicate items. This capability is critical in industries like healthcare (e.g., handling medical instruments) and logistics (e.g., picking varied items). The plurality of reconfigurable fingers provide more contact points with the object, enhancing grip stability and control. This is particularly useful for tasks involving fragile or slippery items, where maintaining a secure hold is crucial.

At least four finger can be independently controlled and reconfigured, allowing the robotic gripper to switch between different grasping modes (e.g., precision grip, power grip). This flexibility makes the robotic gripper suitable for a broad spectrum of tasks without needing tool changes. The independent motion of each finger allows the robotic gripper to navigate and manipulate objects in tight or constrained environments, which is often challenging for traditional robotic hands. By spreading the grasping force across multiple fingers, the robotic gripper of the present disclosure reduces the risk of damaging delicate or sensitive objects, making it ideal for applications like food handling or electronics assembly. The human-like appearance and functionality of a five-finger robotic gripper make it more intuitive and safer for human-robot interaction, improving collaboration in shared workspaces. Even if one finger fails, the robotic gripper of the present disclosure can still function effectively, increasing reliability and fault tolerance during critical tasks. These advantages make the robotic gripper with reconfigurable fingers of the present disclosure particularly suited for advanced robotics applications where versatility, precision, and human-like manipulation are essential.

In accordance with an aspect of the present disclosure, a robotic gripper with reconfigurable fingers includes a trunk, a first movable finger group and a second movable finger group. The trunk is extended in a vertical direction and includes a first layer section and a second layer section arranged from top to bottom. The first movable finger group includes a first rotating support portion, a first bracket actuator, a first bracket, at least one first finger actuator, an extension rod and a first finger, wherein the first rotating support portion is arranged on the first layer section, and the first bracket actuator is arranged on the first rotating support portion, connected to the first bracket, and configured to drive the first bracket to rotate relative to the first rotating support portion, wherein the at least one first finger actuator and the extension rod are arranged on the first bracket and spatially corresponding to the first layer section and the second layer section, respectively, wherein the first finger is arranged at a bottom end of the extension rod, and the first finger is connected to the at least one first finger actuator through the extension rod and driven by the at least one first finger actuator. The second movable finger group includes a second rotating support portion, a second bracket actuator, a second bracket, at least one second finger actuator and a second finger, wherein the second rotating support portion is arranged on the second layer section, and the second bracket actuator is arranged on the second rotating support portion, connected to the second bracket, and configured to drive the second bracket to rotate relative to the second rotating support portion, wherein the at least one second finger actuator is arranged on the second bracket and spatially corresponding to the second layer section, wherein the second finger is arranged at a bottom end of the second bracket, connected to the at least one second finger actuator, and driven by the at least one second finger actuator, wherein the first finger and the second finger are located at an identical horizontal height.

In an embodiment, the trunk includes a top end fixed to a robot arm connection portion.

In an embodiment, the first movable finger group includes at least one first insertion slot disposed at the bottom end of the extension rod and configured to connect the first finger.

In an embodiment, the second movable finger group includes at least one second insertion slot disposed at the bottom end of the second bracket and configured to connect the second finger, wherein the at least one first insertion slot and the at least one second insertion slot are located at the identical horizontal height.

In an embodiment, the first bracket actuator controls the first bracket to rotate relative to the first rotating support portion within an angle range between −75 degrees and 75 degrees, and the second bracket actuator controls the second bracket to rotate relative to the second rotating support portion within an angle range between −75 degrees and 75 degrees.

In an embodiment, two of the first bracket actuators, two of the first brackets, two of the first finger actuators, two of the extension rods and two of the first fingers are arranged in pairs, and the two first brackets, the two of the first finger actuators, the two of the extension rods and the two of the first fingers are respectively arranged on two opposite lateral and outer sides of the second movable finger group.

In an embodiment, two of the second bracket actuators, two of the second brackets, two of the second finger actuators and two of the second fingers are arranged in pairs and disposed between the two extension rods and between the two first fingers.

In an embodiment, the robotic gripper with reconfigurable fingers further includes at least one third finger actuator and a third finger, wherein the at least one third finger actuator is arranged on the second layer section of the trunk, and the third finger is arranged at a bottom end of the trunk, connected to the at least one third finger actuator, and driven by the at least one third finger actuator.

In an embodiment, the third finger, the first finger and the second finger are located at the identical horizontal height.

In an embodiment, each of the first finger, the second finger and the third finger includes a plurality of finger segments and an actuation cable. The plurality of finger segments are pivotally connected in series from the base downward to a fingertip, wherein each of the plurality of finger segments includes a body portion, an inner cavity, a first pivot hole, an extruding portion, a second pivot hole and at least one cable hole. The body portion spatially is corresponding to the fingertip and includes a top surface and a bottom surface opposite to each other, and a first side and a second side opposite to each other, wherein the top surface and the bottom surface are connected through the first side and the second side, respectively. The inner cavity is recessed from the bottom surface of the body portion toward the top surface and located between the first side and the second side. The first pivot hole passes the first side and the second side and is in communication with the inner cavity. The extruding portion is disposed on the top surface, located between the first side and the second side, and spatially corresponding to the inner cavity. The second pivot hole passes through the extruding portion and is parallel to the first pivot hole. The at least one cable hole passes through the top surface and the bottom surface, and misaligned with the extruding portion, the inner cavity and the first pivot hole. The extruding portion of a former one close to the fingertip is accommodated in the inner cavity of a latter one close to a fixed end of each adjacent two of the plurality of finger segments, and the first pivot hole of the former one is aligned with the second pivot hole of the latter one and pivotally connected via a pivot shaft, allowing the latter one to swing relative to the former one. The actuation cable is connected to a corresponding one of the first finger actuator, the second finger actuator and the third finger actuator, and connected from the fixed end to the fingertip through the at least one cable hole of the plurality of finger segments in sequence, and then connected from the fingertip to the corresponding one of the first finger actuator, the second finger actuator and the third finger actuator through the at least one cable hole in sequence, wherein the corresponding one of the first finger actuator, the second finger actuator and the third finger actuator controls a tension of the actuation cable to control a posture and hardness of the corresponding one of the first finger, the second finger and the third finger.

In an embodiment, each of the plurality of finger segments includes a protective skin, the protective skin includes an upper opening and a lower opening, and the body portion is arranged on an outer periphery of the body portion through the upper opening and the lower opening.

In an embodiment, the protective skin includes a stopper, which is respectively arranged adjacent to a periphery of the upper opening and a periphery of the lower opening, protruding from outside to inside, and abutting against the top surface and the bottom surface to fix the protective skin to the outer periphery of the body portion.

In an embodiment, each of the fingertips of the plurality of finger segments includes a protective skin having an upper opening, the body portion passes through the upper opening so that the protective skin is arranged on an outer surface of the body portion.

In an embodiment, the protective skin includes a stopper, which is disposed adjacent to a periphery of the upper opening, protrudes from outside to inside, and abuts against the top surface to fix the protective skin to the outer surface of the body portion.

In an embodiment, each adjacent two of the plurality of finger segments have the former one close to the fingertip and the latter one close to the fixed end, the former one close to the fingertip is allowed to swing within an angle range relative to the latter one close to the base, and the angle range is between 120 degrees and −120 degrees.

In an embodiment, each of the plurality of finger segments further includes a hollow structure penetrating the first side and the second side, in communication with the inner cavity, and arranged parallel to the first pivot hole.

In an embodiment, each of the first finger, the second finger and the third finger includes at least one tactile sensor disposed at the fingertip and configured to sense pressure or sliding information of the first finger, the second finger and the third finger in contact with an object.

In an embodiment, each of the first finger actuator, the second finger actuator and the third finger actuator drives the actuation cable to change the tension through rotation.

In an embodiment, the first finger, the second finger and the third finger grasp an object by perform form closure and/or force closure.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A to FIG. 1C are schematic structural views illustrating a robotic gripper with reconfigurable fingers according to an embodiment of the present disclosure but with fingers omitted;

FIG. 2 is a side view illustrating the robotic gripper with reconfigurable fingers according to the embodiment of the present disclosure but with fingers omitted;

FIG. 3 is a schematic structural illustrating the trunk, the first bracket and the second bracket according to the embodiment of the present disclosure;

FIG. 4A to FIG. 4B schematically illustrate the fingers used in the robotic gripper with reconfigurable fingers according to the embodiment of the present disclosure;

FIG. 5A and FIG. 5B are schematic structural views illustrating one finger segment of the finger in FIG. 4A from different perspective;

FIG. 6 schematically shows two adjacent finger segments of the finger in FIG. 4A sequentially pivoted and the connection of the actuation cable;

FIG. 7A schematically shows the finger in FIG. 4A moved inwardly close to the object;

FIG. 7B schematically shows the finger in FIG. 4A moved away from the object;

FIG. 8A is a schematic structural view illustrating the protective skin according the embodiment of the present disclosure;

FIG. 8B is a side view illustrating the protective skin according to the embodiment of the present disclosure; and

FIG. 9A to FIG. 9E schematically illustrate various configurations of the robotic gripper with reconfigurable fingers according the embodiment of the present disclosure.

Persons skilled in the art will appreciate that elements in the figures are illustrated for simplicity and clarity and may have not been drawn to scale. For example, the dimensions of some of the elements in the figures may be exaggerated relative to the other elements to help to improve understanding of various exemplary embodiments of the present disclosure. Throughout the drawings, it should be noted that reference signs are used to depict the same or similar elements, features, and structures.

### DETAILED DESCRIPTION OF THE PREFERRED EMBODIMENT

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed. Further, spatially relative terms, such as “upper,” “lower,” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

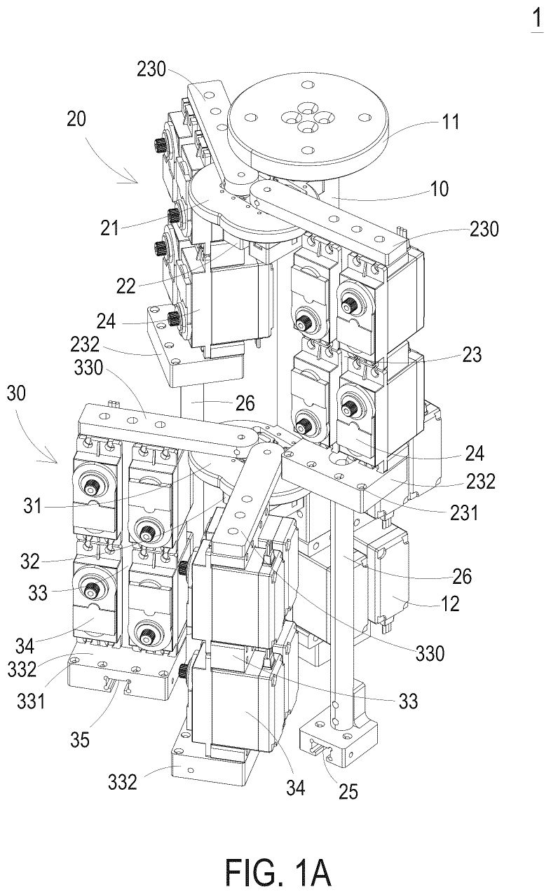

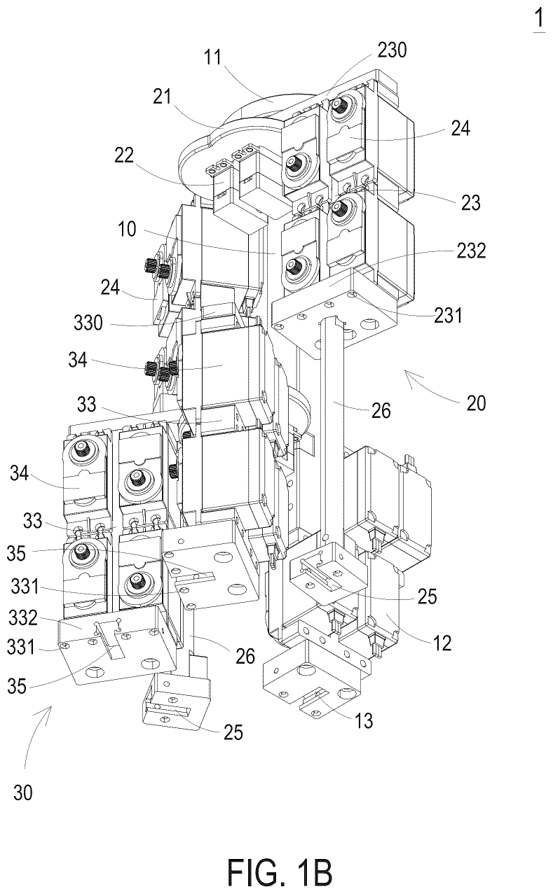

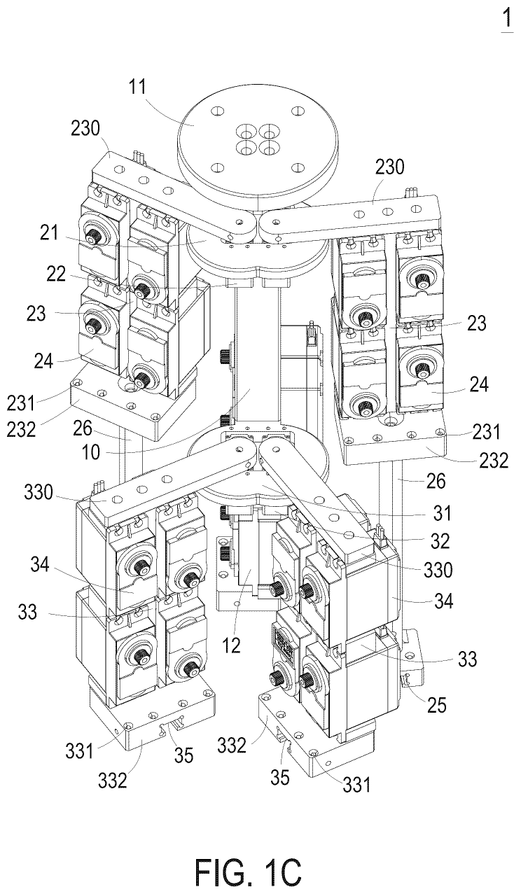

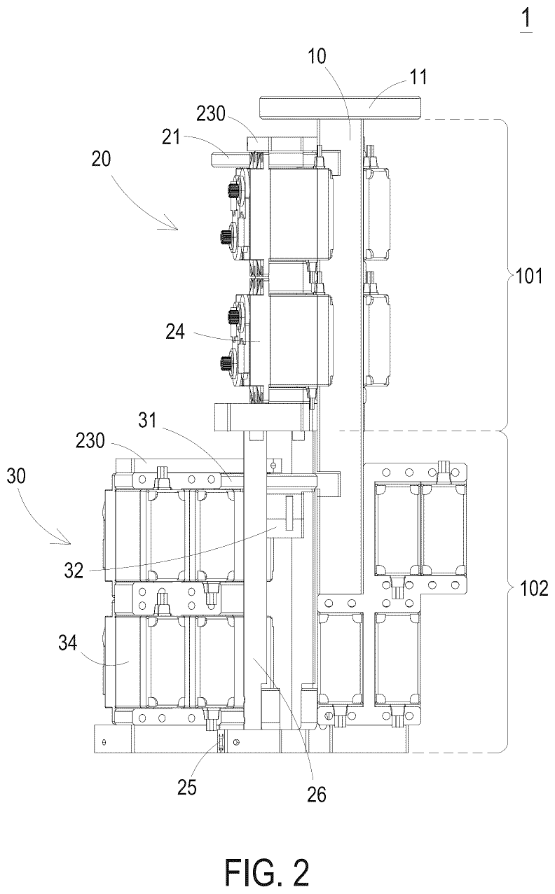

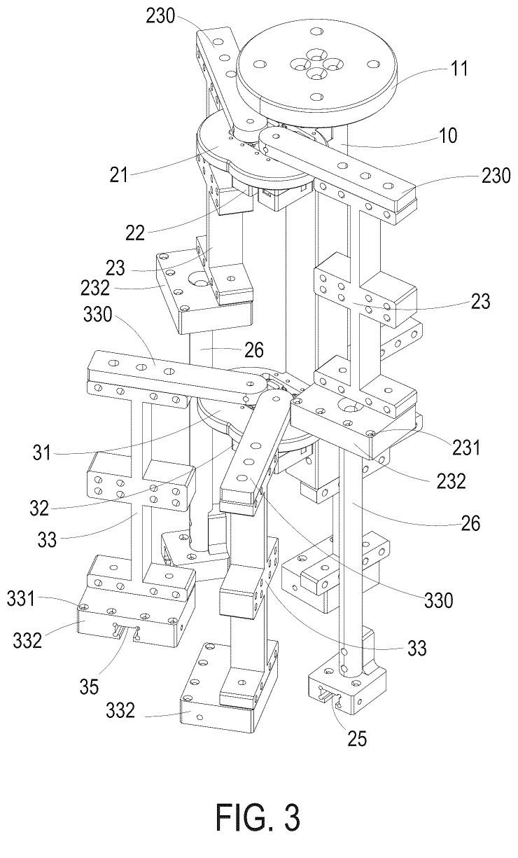

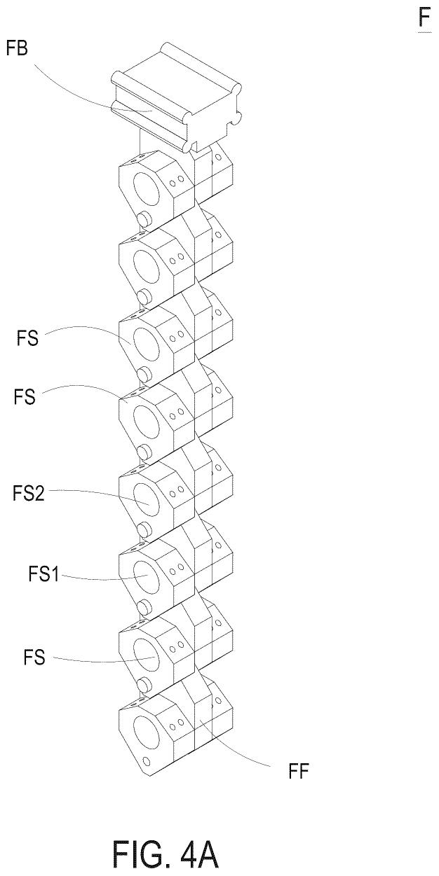

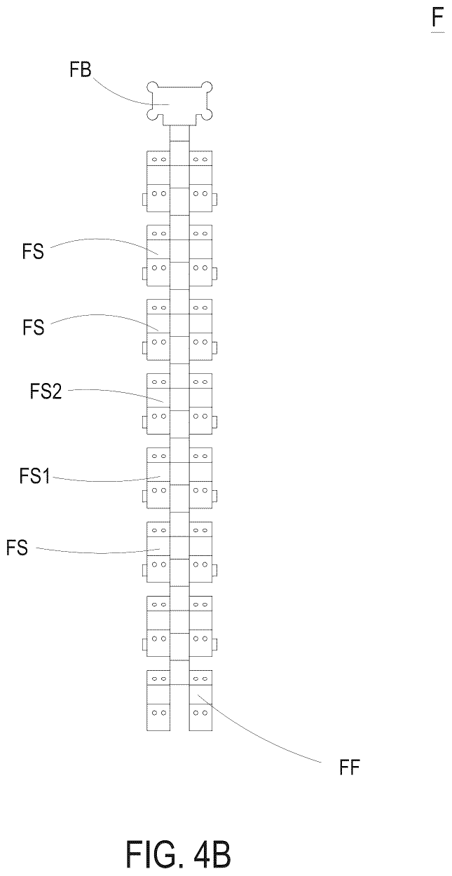

FIG. 1A to FIG. 1C are schematic structural views illustrating a robotic gripper with reconfigurable fingers according to an embodiment of the present disclosure but with fingers omitted. FIG. 2 is a side view illustrating the robotic gripper with reconfigurable fingers according to the embodiment of the present disclosure but with fingers omitted. FIG. 3 is a schematic structural illustrating the trunk, the first bracket and the second bracket according to the embodiment of the present disclosure. FIG. 4A to FIG. 4B schematically illustrate the fingers used in the robotic gripper with reconfigurable fingers according to the embodiment of the present disclosure. In the embodiment, a robotic gripper (1) with reconfigurable fingers is proposed that can adapt to a variety of grasping configurations while ensuring that its cross-sectional area in the transverse plane is compact enough to implement various applications. The robotic gripper (1) includes a trunk (10), a first movable finger group (20) and a second movable finger group (30). The trunk (10) is extended in a vertical direction and includes a first layer section (101) and a second layer section (102), which are arranged from top to bottom. The first movable finger group (20) includes a first rotation support portion (21), a first bracket actuator (22), a first bracket (23), at least one first finger actuator (24), an extension rod (26) and a first finger (F). The first rotating support portion (21) is arranged on the first layer section (101). The first bracket actuator (22) is arranged on the first rotating support portion (21), connected to the first bracket (23), and configured to drive the first bracket (23) to rotate relative to the first rotating support portion (21). The at least one first finger actuator (24) arranged on the first bracket (23) and the extension rod (26) are spatially corresponding to the first layer section (101) and the second layer section (102), respectively. The first finger (F) (refer to FIG. 4A and FIG. 4B) is disposed at a bottom end of the extension rod (26). The first finger (F) is connected to at least one first finger actuator (24) through the extension rod (26) and driven by at least one first finger actuator (24). Furthermore, in th3 embodiment, the second movable finger group (30) includes a second rotating support portion (31), a second bracket actuator (32), a second bracket (33), at least one second finger actuator (34) and a second finger (F). The second rotating support portion (31) is arranged on the second layer section (102). The second bracket actuator (32) is arranged on the second rotating support portion (31), connected to the second bracket (33), and configured to drive the second bracket (33) to rotate relative to the second rotating support portion (31). The at least one second finger actuator (34) is arranged on the second bracket (33), and spatially corresponding to the second layer section (102). The second finger (F) (refer to FIG. 4A and FIG. 4B) is arranged at a bottom end of the second bracket (33), connected to the at least one second finger actuator (34), and driven by the at least one second finger actuator (34). The first finger (F) and the second finger (F) have the same structure, and the structures are located at an identical horizontal height.

In the embodiment, the first movable finger group (20) includes two first bracket actuators (22), two first brackets (23), eight first finger actuators (24), two extension rods (26) and two first fingers (F), which are arranged in pairs. The two first brackets (23) have the rotating arms (230) connected to the first rotating support portion (21) and extend outward at a relatively larger angle, so that the two first brackets (23), the eight first finger actuators (24), the two extension rods (26) and the two first fingers (F) are arranged on two opposite lateral and outer sides of the second movable finger group (30). In th3 embodiment, the second movable finger group (30) includes two second bracket actuators (32), two second brackets (33), eight second finger actuators (34) and two second fingers (F), which are arranged in pairs. The two second brackets (33) have the rotating arms (330) connected to the second rotating support portion (31) and extended outward at a relatively smaller angle, respectively, so that the eight second bracket actuators (32), the two second brackets (33), the two second finger actuators (34) and the two second fingers (F) are arranged between the two extension rods (26) and the two first fingers (F).

In the embodiment, the robotic gripper (1) further includes at least one third finger actuator (12) and a third finger (F). The at least one third finger actuator (12) is arranged at the second layer section (102) of the trunk (10), and spatially corresponding to and disposed between the two extension rods (26). The third finger (F) (refer to FIG. 4A and FIG. 4B) is disposed at a bottom end of the trunk (10), connected to at least one third finger actuator (12), and driven by at least one third finger actuator (12).

From the above, the robotic gripper (1) of the present disclosure has a total of 5 fingers. That is, two first fingers (F), two second fingers (F) and one third finger (F), respectively. Except that the position of the third finger (F) on the trunk (10) cannot be reconfigured relative to the trunk (10), the two first fingers (F) driven by the two rotating arms (230) of the first movable finger group (20) and the two second fingers (F) driven by the two rotating arms (330) of the second movable finger group (30) can be reconfigured relative to the trunk (10). The top end (11) of the main support (10) is fixed to a robot arm connection portion. The first rotating support portion (21) of the first movable finger group (20) and the second rotating support portion (31) of the second movable finger group (30) are respectively installed on the first layer section (101) and the second layer section (102) at different horizontal heights of the trunk (10). The two first bracket actuators (22) of the first movable finger group (20) are respectively installed at the centers of the first rotating support portions (21) to drive the two rotating arms (230). The two second bracket actuators (32) of the second movable finger group (30) are respectively installed at the centers of the second rotating support portions (31) to drive the two rotating arms (330).

The first set of rotating support portion (21) is connected to the trunk (10) at the first layer section (101), and two upper rotating arms (230) are assembled to the first rotating support portion (21). The first bracket actuators (22) are located on the first rotation support portion (21). The upper rotating arms (230) are located above the first rotating support portion (21), one end of which is connected to the first bracket actuator (22), and the other end of which is connected to the first bracket (23) accommodating the first movable finger group (20). The inner end of the rotating arm (230) is electrically connected to the first bracket actuator (22) for driving the rotating arm (230) through the first bracket actuator (22) to rotate and extended outward with a predetermined arm length. The outer end of the rotating arm (230) is connected with the first bracket (23), which is used to place the first finger actuator (24) and corresponding to the first finger (F). The first bracket (23) has a middle plate (232) with cable holes (231) for the actuation cables to pass through. The extension rod (26) is attached to the middle plate (232) for placing the first finger (F). The first finger actuator (24) is arranged on the middle plate (232) of the first bracket (23) and is used to drive an actuation cable (not shown) of the finger. The actuation cable passes through the cable hole (231) and is connected to the first finger (F). In the embodiment, a first insertion slot (25) is provided on the bottom end of the extension rod (26), which is configured to connect the first finger (F). The fixed end (FB) of the first finger (F) can be inserted in to the first insertion slot (25). The length of the extension rod (26) can ensure that the first finger (F) and the second finger (F) are aligned in the same plane in the initial position.

The second rotating support portion (31) is connected to the trunk (10) at the second layer section (102), and two lower rotating arms (330) are assembled to the second rotating support portion (31). The height of the first layer section (101) and the second layer section (102) is greater than a combined height of the actuator modules including the bracket actuator and the finger actuator. The lower rotating arm (330) is assembled to the second rotating support portion (31) in a similar manner to the upper rotating arm (230). The second finger actuators (34) are arranged on the middle plate (332) of the second bracket (33) and are used to drive the actuation cables (not shown) of the finger. The actuation cable passes through the cable hole (331) and is connected to the second finger (F). In the embodiment, the lower rotating arm (330) is not provided with an extension rod, and the second finger (F) is directly assembled on the middle plate (332) of the second bracket (33). Therefore, the second bracket (33) connected to the lower rotating arm (330) can have a second insertion slot (35) on the bottom side of the middle plate (332), which is configured to connect the second finger (F). The fixed end (FB) of the second finger (F) can be inserted into the second insertion slot (35). In addition, the bottom end of the trunk (10) also has a third insertion slot (13) which is assembled and connected to the third finger (F). The fixed end (FB) of the third finger (F) can be inserted into the third insertion slot (13). In the embodiment, the first insertion slot (25), the second insertion slot (35) and the third insertion slot (13) are located at the identical horizontal height. The third finger (F) is aligned at the same level as the first finger (F) and the second finger (F) in an initial position.

In other words, the robotic gripper (1) with reconfigurable fingers in the present disclosure includes a fixed finger and a plurality of reconfigurable fingers. The first fingers (F) of the first movable finger group (20) and the second fingers (F) of the second movable finger group (30) can be repositioned and reoriented. In order to maximize the range of motion of each reconfigurable finger while minimizing the occupied area of the robotic gripper (1) in the transverse plane, the plurality of first movable finger groups (20) and the second movable finger groups (30) can be divided into a two-layer or multi-layer architecture. The reconfigurable fingers corresponding to each of the first movable finger groups (20) and the second movable finger groups (30) are designed to be able to swing horizontally within ±75 degrees. In the embodiment, the first bracket actuator (22) controls the rotating arm (230) of the first bracket (23) to rotate relative to the first rotating support portion (21) within an angle range between −75 degrees and 75 degrees. Similarly, the second bracket actuator (32) controls the rotating arm (330) of the second bracket (33) to rotate relative to the second rotating support portion (31) within an angle range between −75 degrees and 75 degrees. Notably, the vertical heights of the first layer section (101) and the second layer section (102) are not an essential technical feature to limit the present disclosure and adjustable according to the practical requirements, which will not be redundantly described hereafter.

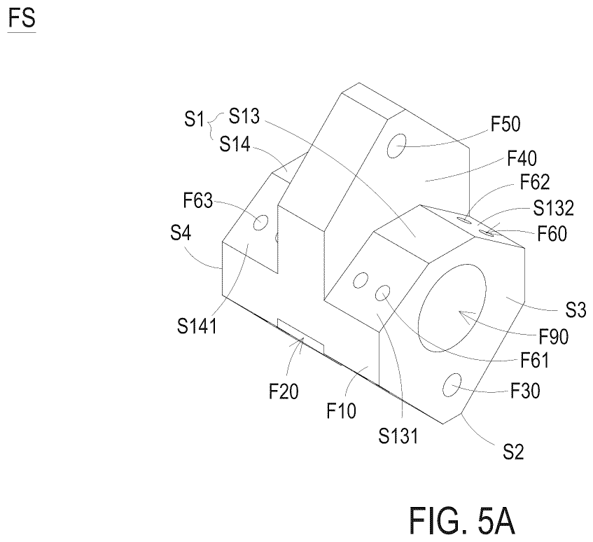

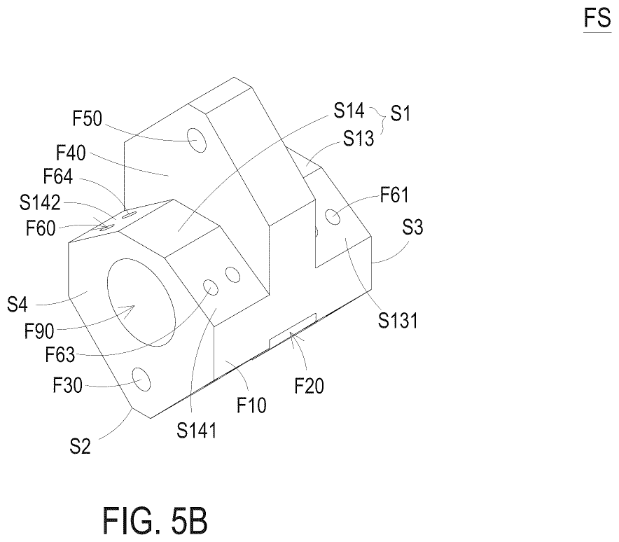

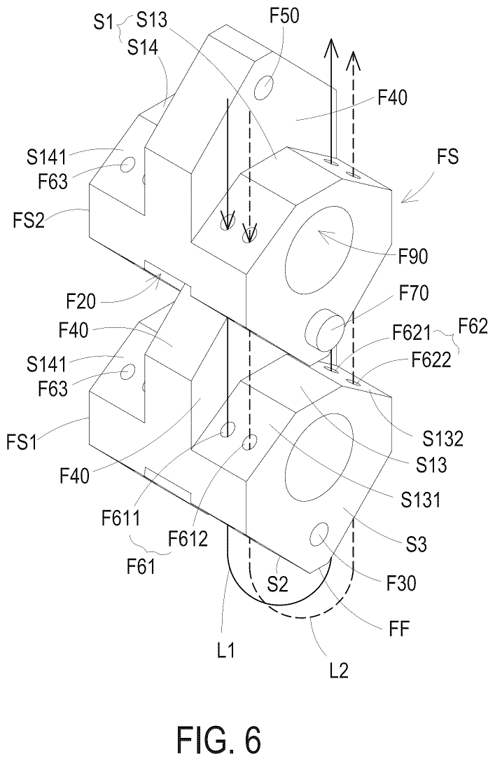

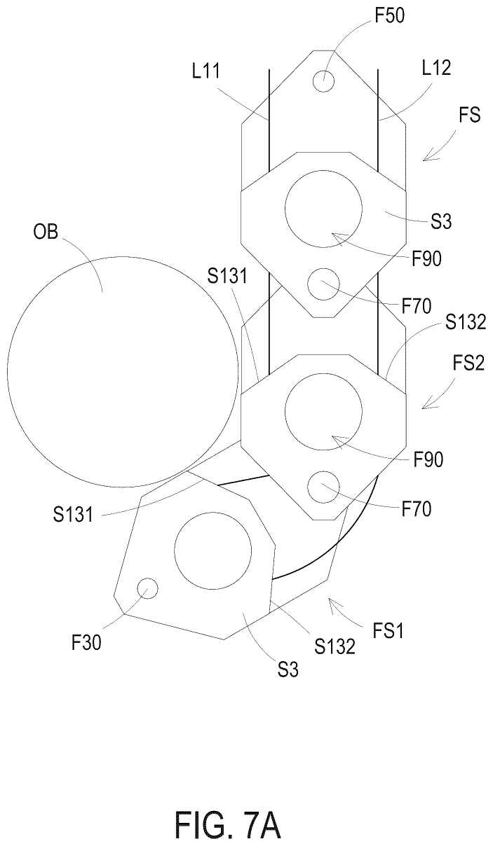

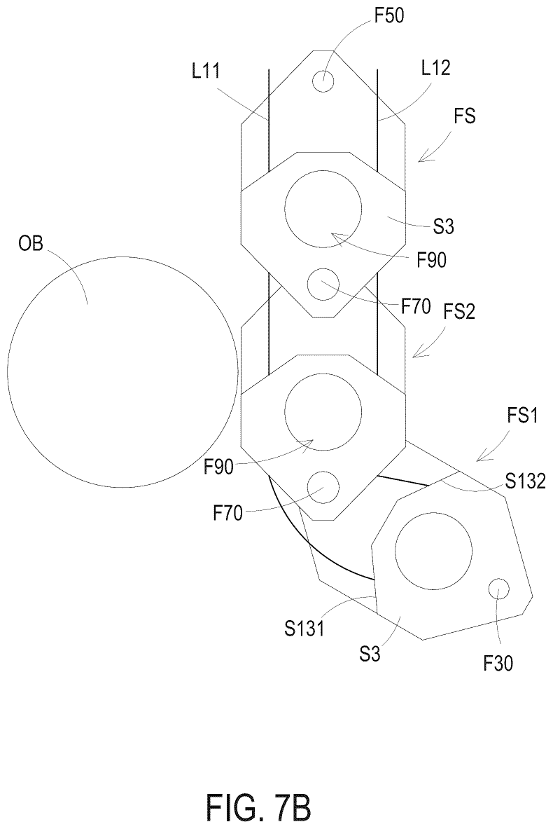

Notably, the first finger actuator (24) drives the first finger (F), the second finger actuator (34) drives the second finger (F), and the third finger actuator (12) drives the third finger (F) in the same manner. The following description is simplified by using only a single finger (F) for illustration, but is not intended to limit the present disclosure. In the embodiments, each finger (F) has an identical length and driven by four finger actuators. That is, there are four actuation cables for controlling the movement of one single finger (F), and each actuation cable is connected to one finger actuator, so as to be controlled. The four through holes (231) on the first bracket (23) and the four through holes (331) on the second bracket (33) allow corresponding actuation cables to pass through and be connected to corresponding fingers (F). Four actuation cables are used to control the inward and outward movement of the fingers, respectively. FIG. 5A and FIG. 5B are schematic structural views illustrating one finger segment of the finger in FIG. 4A from different perspective. FIG. 6 schematically shows two adjacent finger segments of the finger in FIG. 4A sequentially pivotally connected and the connection of the actuation cable. FIG. 7A schematically shows the finger in FIG. 4A moved inwardly close to the object. FIG. 7B schematically shows the finger in FIG. 4A moved away from the object. In the embodiment, each finger (F) includes a plurality of finger segments (FS), and the plurality of finger segments (FS) of each finger (F) are sequentially pivotally connected downward from a fixed end (FB) in the insertion slot to a fingertip (FF). In the embodiment, each finger has eight finger segments (FS), and each of the eight finger segments (FS) includes a body portion (F10), an inner cavity (F20), a first pivot hole (F30), an extruding portion (F40), a second pivot hole (F50) and at least one cable hole (F60). The body portion (F10) is spatially corresponding to the fingertip (FF) and has a top surface (S1) and a bottom surface (S2) opposite to each other, and a first side (S3) and a second side (S4) opposite to each other. The top surface (S1) and the bottom surface (S2) are connected to each other through the first side (S3) and the second side (S4), respectively. The top surface (S1) faces the fixed end (FB), and the bottom surface (S2) faces the fingertip (FF). The inner cavity (F20) is recessed from the bottom surface (S2) toward the top surface (S1) of the body portion (F10), and located between the first side (S3) and the second side (S4). The first pivot hole (F30) passes through the first side (S3) and the second side (S4), and is in communication with the inner cavity (F20). The extruding portion (F40) is disposed on the top surface (S1), arranged between the first side (S3) and the second side (S4), and spatially corresponding to the inner cavity (F20). In the embodiment, the size and the shape of the inner cavity (F20) and the extruding portion (F40) are matched with each other. That is, the size and the shape of the inner cavity (F20) is corresponding to the size and the shape of the extruding portion (F40), and the vertical cross-sections of the body portion (F10) and the extruding portion (F40) are polygonal. The second pivot hole (F50) passes through the extruding portion (F40) and is parallel to the first pivot hole (F30). The at least one cable hole (F60) passes through the top surface (S1) and the bottom surface (S2), and is misaligned with the extruding portion (F40), the inner cavity (F20) and the first pivot hole (F30) in view of the vertical direction. In the embodiment, the extruding portion (F40) of a former one (FS1) close to the fingertip (FF) is accommodated in the inner cavity (F20) of a latter one (FS2) close to a fixed end (FB) of each adjacent two of the plurality of finger segments (FS), and the second pivot hole (F50) of the former one (FS1) is aligned with the first pivot hole (F30) of the latter one (FS2) and pivotally connected via a pivot shaft (F70), allowing the latter one (FS2) to swing relative to the former one (FS1). Certainly, in other embodiments, the connections of multiple fingers (FS) are implemented through different types of connectors. The actuation cable is connected to the finger actuator and connected from the fixed end (FB) to the fingertip (FF) through the at least one cable hole (F60) of the plurality of finger segments (FS) in sequence, and then connected from the fingertip (FF) to the finger actuator through the at least one cable hole (F60) in sequence. In the embodiment, the finger actuator controls a tension of the actuation cables (L1, L2) to control a posture and hardness of the finger (F).

In the embodiment, each finger segment (FS) has a front-to-back and left-to-right symmetrical structure. The extruding portion (F40) is located between the first side (S3) and the second side (S4), and configured to divide the top surface (S1) into a first-side top surface (S13) and a second-side top surface (S14). The first-side top surface (S13) is connected between the extruding portion (F40) and the first side (S3), and the second-side top surface (S14) is connected between the extruding portion (F40) and the second side (S4). The least one cable hole (F60) is arranged on the first-side top surface (S13) or the second-side top surface (S14) for the actuation cables (L1, L2) to pass through and realize tension control. In the embodiment, the first-side top surface (S13) includes a first sub-slope (S131) and a second sub-slope (S132), and the first sub-slope (S131) and the second sub-slope (S132) are respectively located on two opposite sides of the first pivot hole (F30). The second side top surface (S14) includes a third sub-slope (S141) and a fourth sub-slope (S142), and the third sub-slope (S141) and the fourth sub-slope (S142) are respectively located on two opposite sides the first pivot hole (F30). The first sub-slope (S131) and the third sub-slope (S141) are located on the same side of the first pivot hole (F30), and the at least one cable hole (F60) includes a first cable hole (F61), a second cable hole (F62), a third cable hole (F63) and a fourth cable hole (F64) arranged on the first sub-slope (S131), the second sub-slope (S132), the third sub-slope (S141) and the fourth sub-slope (S142), respectively. The numbers of the first cable hole (F61), the second cable hole (F62), the third cable hole (F63) and the fourth cable hole (F64) are adjustable according to the practical requirements. In the embodiment, the numbers of the first cable hole (F61), the second cable hole (F62), the third cable hole (F63) and the fourth cable hole (F64) are all two and arranged front to back, allowing four actuation cables to pass through.

In the embodiment, taking the finger (F) configured to clamp an object (OB) as an example, the first sub-slopes (S131) of the plurality of finger segments (FS) are close to the object (OB), and the actuation cable (L1) is connected from the fixed end (FB) to the fingertip (FF) in sequence through the first cable holes (F611) in the plurality of finger segments (FS), and then from the fingertip (FF) to the finger actuator in sequence through the second cable holes (F621). In the embodiment, each finger (F) is driven by an actuation cable (L1) passing through the all finger segments (FS) of the finger (F). The finger actuator may include a cable wheel for rotating the actuation cable, and the rotation causes the actuation cable (L1) to change tension, thereby moving the finger inward or outward. In the embodiment, when the finger actuator controls the actuation cable (L11) to be tightened and shortened relative to the first sub-slopes (S131) (i.e., the left side), and the tension of the primary actuation cable (L12) relative to the second sub-slopes (S132) (i.e., the right side) is released, so that the finger (F) is bent inward toward the object (OB). When the finger actuator controls the actuation cable (L12) to be tightened and shortened relative to the second sub-slopes (S132) (i.e. the right side), and the tension of the primary actuation cable (L11) relative to the first sub-slopes (S131) (i.e. the left side) is released, so that the finger (F) is bent outward away from the object (OB).

In the embodiment, the movement of one single finger (F) can be controlled by the actuation cable (L1) in conjunction with another actuation cable (L2). The first-side top surface (S13) of each finger segment (FS) includes four cable holes (F60). Namely, two first cable holes (F61) are located on the first sub-slope (S131), and two second cable holes (F62) are located on the second sub-slope (S132). The second-side top surface (S14) of each finger segment (FS) includes four cable holes (F60). Namely, two third cable holes (F63) are located on the third sub-slope (S141), and two fourth cable holes (F64) are located on the fourth sub-slope (S132). FIG. 6 illustrates the arrangement of two actuation cables (L1, L2) through the cable holes (F60) on the first-side top surface (S13). In other embodiments, the cable holes (F60) on the second-side top surface (S14) may also be provided with two actuation cables, but the present disclosure is not limited thereto.

In the embodiment, the actuation cable (L1) passes through the first cable hole (F611) at the corresponding position, turns back at the fingertip (FF), passes through the second cable hole (F621), and is controlled by the finger actuator. The finger actuator may include a cable wheel for rotating the actuation cable, which is controlled by the tension of the actuation cable (L1) to move the finger inward or outward. In the embodiment, another actuation cable (L2) can be selectively connected from the fixed end (FB) to a specific finger segment (FS), not limited to the fingertip (FF), through the first cable hole (F612) in the finger segments (FS), and then connected to the finger actuator through the second cable hole (F622) in sequence from the specific finger segment. By selectively passing the actuation cable (L2) through all or part of the plurality of finger segments (FS), a segmented control can be achieved. Certainly, in other embodiments, different actuation cables (L2) selectively pass through the first cable holes (F61), the second cable holes (F62), the third cable holes (F63) or the fourth cable holes (F64) of the plurality of finger segments (FS) from the fixed end (FB) to achieve the segmented control for more control degree of freedom.

Notably, the number and position of the cable holes (F60) are adjustable according to the practical requirements. When the four actuation cables are used to control the movement of the finger (F), four or eight cable holes (F60) may be provided on the first sub-slope (S131), the second sub-slope (S132), the third sub-slope (S141) and the fourth sub-slope (S142) of the top surface (S1). The size or dimension of the through hole (F60) is determined by the actuation cables selected and the number of actuation cables passing through the cable holes (F60). The actuation cables are made of light-weight materials and the tensile or tension strength should be strong enough for handling required payload ranges.

When the plurality of finger segments (FS) are assembled together, each finger segment (FS) is capable to rotate around the shaft. Preferably but not exclusively, in the embodiment, the finger segment (FS) is capable to rotate around the pivot shaft (F70). The maximum rotation range between two-connected adjacent finger segments (FS) may be determined by the design of the extruding portion (F40) and the inner cavity (F20), and is typically designed to be of the same rotation range in the inward and outward directions. In the embodiment, for each two adjacent ones of the plurality of finger segments (FS), the former one (FS1) close to the fingertip (FF) is allowed to swing within an angle range relative to the latter one (FS2) close to the fixed end (FB), and the angle range is between 120 degrees and −120 degrees. Certainly, the total rotation range of the finger (F) may be greater than the rotation range of two-connected finger segment (FS), and different segments (FS) may rotate in different angles and directions. In this way, the robotic gripper 1 with the plurality of fingers (F) is capable to grip objects of various geometry.

In the embodiment, each of the plurality of finger segments (FS) further includes a hollow structure (F90) penetrating the first side (S3) and the second side (S4), in communication with the inner cavity (F20), and arranged parallel to the first pivot hole (F30). The hollow design of the hollow structure (F90) can reduce the weight of the finger segments (FS) and reduce the material cost. In the embodiment, each finger segment (FS) can be manufactured by 3D printing, injection molding or other manufacturing processes. Taking 3D printing as an example, the hollow structure (F90) on the body portion (F10) can reduce the weight of the finger segments (FS).

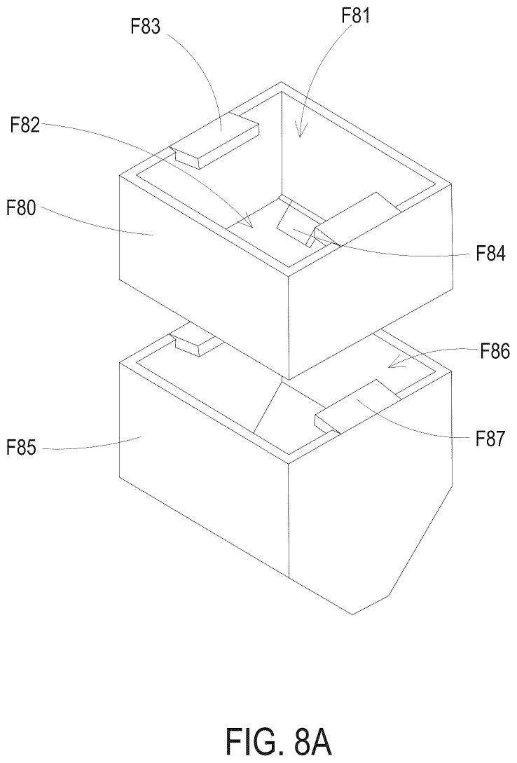

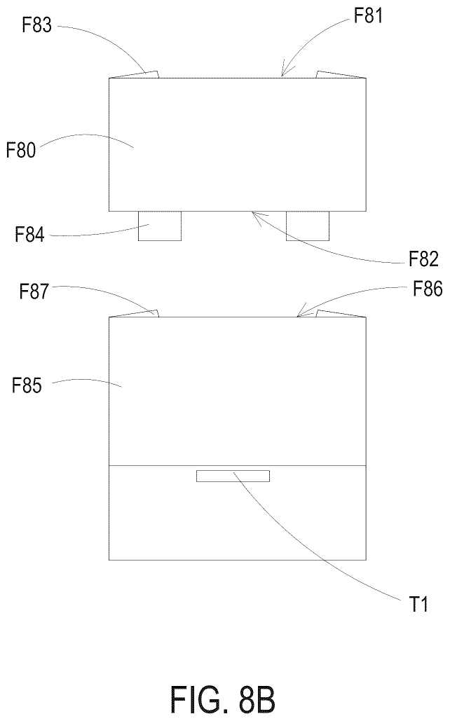

FIG. 8A is a schematic structural view illustrating the protective skin according the embodiment of the present disclosure. FIG. 8B is a side view illustrating the protective skin according to the embodiment of the present disclosure. Please refer to FIG. 4A to FIG. 8B. In the embodiment, each of the plurality of finger segments (FS) includes a protective skin (F80). The protective skin (F80) includes an upper opening (F81) and a lower opening (F82), and the body portion (F10) is arranged on an outer periphery of the body portion (F10) through the upper opening (F81) and the lower opening (F82). In the embodiment, the protective skin (F80) includes stoppers (F83, F84), which are respectively arranged adjacent to a periphery of the upper opening (F81) and a periphery of the lower opening (F82), protruding from the outside to the inside, and abutting against the top surface (S1) and the bottom surface (S2) to fix the protective skin(F80) to the outer periphery of the body portion (F10). The stoppers (F83, F84) are not limited to corresponding arrangements or offset arrangements. In addition, a protective skin (F85) is provided for the fingertip (FF) of the plurality of finger segments (FS). The protective skin (F85) includes an upper opening (F86). The body portion (F10) passes through the upper opening (F86) so that the protective skin (F85) is arranged on an outer surface of the body portion(F10). Similarly, the protective skin (F85) includes a stopper (F87) which is disposed adjacent to a periphery of the upper opening (F86), protrudes from the outside to the inside, and abuts against the top surface (S1) to fix the protective skin (F85) to the outer surface of the body portion(F10). The protective skins (F80, F85) are made of soft materials and can be easily assembled with the finger segments (FS). The size, the shape and the dimensions of the protective skins (F80, F85) generally conform with the body portion (F10) of the finger segments (FS) so that the protective skins (F80, F85) can be properly and firmly attached with the finger segments (FS). In the embodiment, the inner surface of the protective skins (F80, F85) can be configured to have coarse texture or anti-slip design to enhance the attachment of the protective skins (F80, F85) and the finger segments (FS).

In the embodiment, each of the plurality fingers (F) includes at least one tactile sensor (T1), which is arranged on the fingertip (TT) or the outer surface or inner wall of the protective skin (F85), and configured to sense the pressure or sliding information of the contact between the plurality of fingers (F) and the object (OB). Preferably but not exclusively, in the embodiment, the tactile sensor (T1) can be disposed on the outer surface of the protective skin (F85), or the tactile sensor (T1) is disposed on the contact side of the protective skin (F85) and the object (OB) to sense the force or pressure acting on the finger segments (FS). In other embodiments, the shape of the protective skin (F85) may also be adjusted according to the practical requirements, and the present disclosure is not limited thereto. In addition, in the embodiment, the controller is connected to the finger actuator and at least one tactile sensor (T1) and configured to receive a signal input from the tactile sensor (T1) and dynamically adjust the tension of the actuation cables (L1, L2) according to the signal input to provide force/slip feedback during the grasping operations. In the embodiment, the tactile sensor (T1) may be, for example, a force sensitive resistor (FSR), a tactile sensor, a pressure sensor or other appropriate sensors. In other embodiments, the sensor may be configured to detect external parameters such as pressure, vibration, texture, temperature, hardness, shape, and/or size. The selection of sensor may depend on sensitivity requirements, task demand or user's choice. The sensor signals may be processed and utilized for control of the robotic gripper 1 to adjust the gripping force and/or gripping gesture. Certainly, the present disclosure is not limited thereto.

Certainly, the manner in which the first finger actuator (24) drives the first finger (F), the second finger actuator (34) drives the second finger (F), and the third finger actuator (12) drives the third finger (F) is not limited to the above-mentioned embodiment. By different configurations of the lengths of the actuation cables, the plurality of fingers (F) can implement various combination of multiple degrees of freedom. In other embodiments of the present disclosure, the lengths of the first fingers (F), the second fingers (F), and the third fingers (F) may be different. For example, the length of the second fingers (F) may be shorter or longer than the other fingers. In another example, the length of the fingers may be determined regardless of the third finger (F).

In another embodiment of the present disclosure, the robotic gripper has more layers and more fingers. For example, it can be extended to 7 fingers in three layers, in which upper layer rotating arms and middle layer rotating arms would have extension rods of different lengths. Notably, the rotation ranges of the rotating arms can be narrower as the number of rotating arms is increased. Certainly, the present disclosure is not limited thereto.

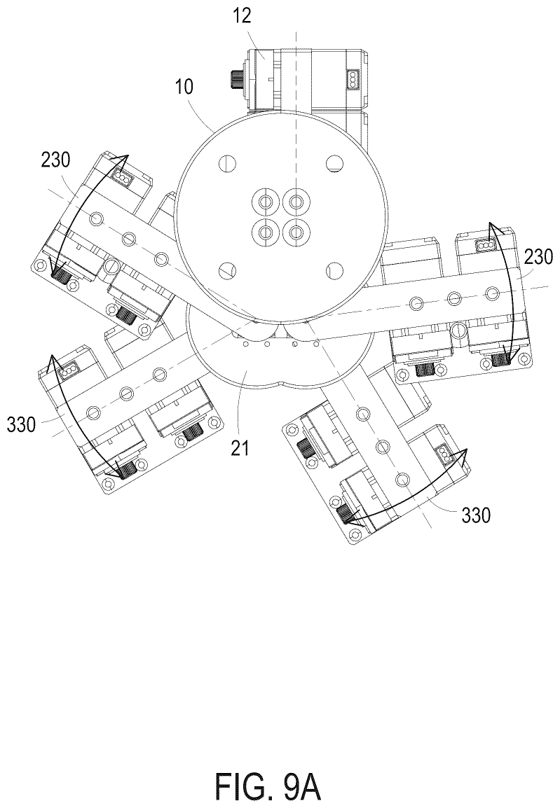

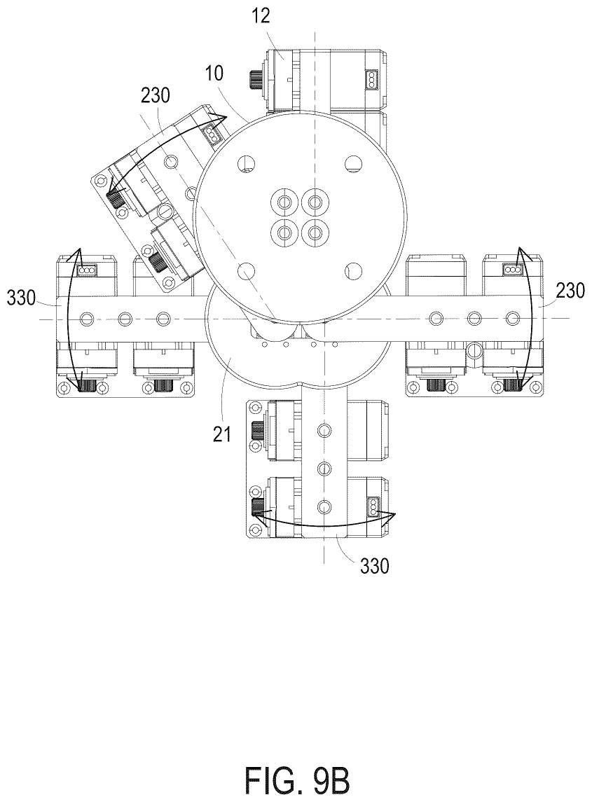

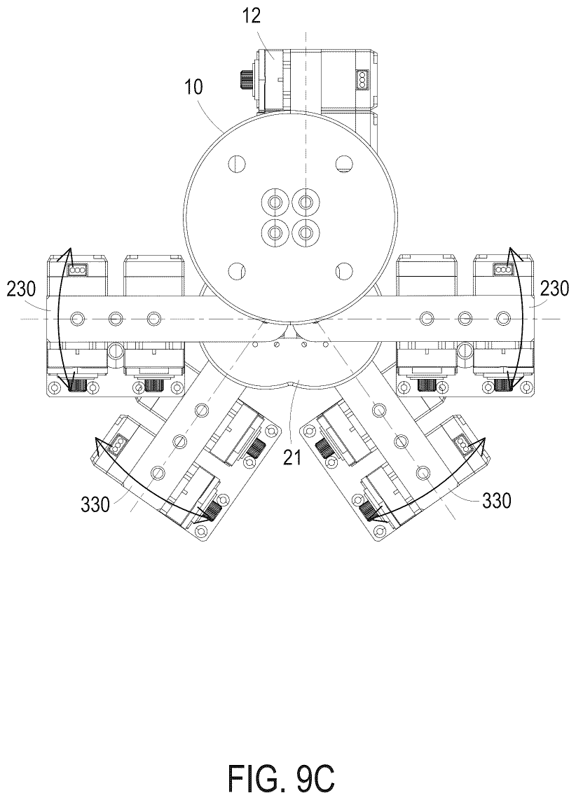

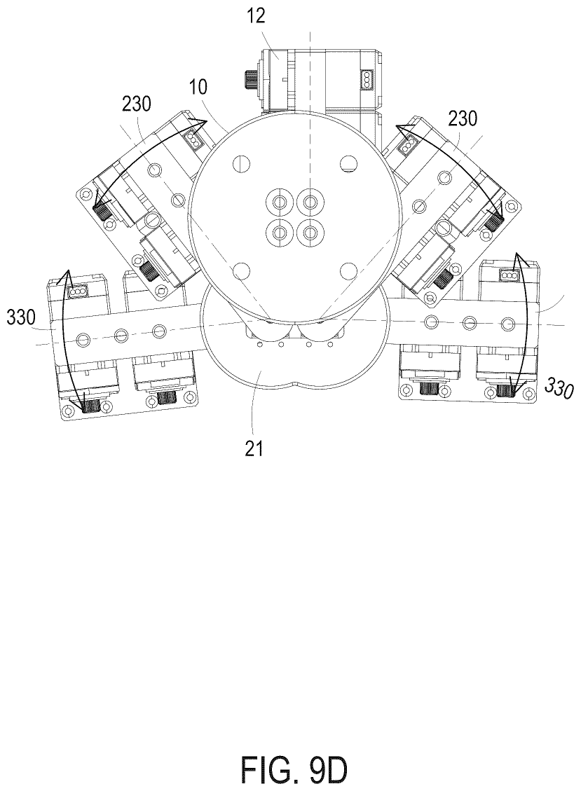

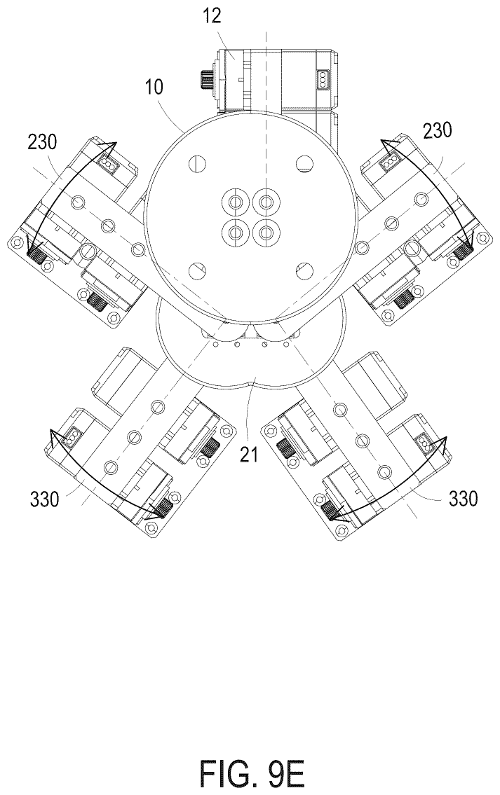

FIG. 9A to FIG. 9E schematically illustrate various configurations of the robotic gripper with reconfigurable fingers according the embodiment of the present disclosure. As can be seen from the figure, the robotic gripper 1 with reconfigurable fingers in the present disclosure can achieve various grasping configurations by different unit groupings of fingers. FIG. 9A to FIG. 9E illustrate several representative examples from different perspectives. In a default pose, each finger (F) corresponding to the trunk (10) and the rotating arms (230, 330) is distributed equally in a circle, as shown in FIG. 9A. In a specific pose, the trunk (10) and the corresponding fingers (F) of the rotating arms (230, 330) can be perpendicular to each other, as shown in FIG. 9B and FIG. 9C. In another specific pose, all fingers (F) corresponding to the trunk (10) and the rotating arms (230, 330) can be concentrated in a certain area, as shown in FIG. 9D. In a further specific pose, all fingers (F) corresponding to the trunk (10) and the rotating arms (230, 330) are evenly spread out, as shown in FIG. 9E. Certainly, the robotic gripper 1 with reconfigurable fingers in the embodiments can have more configurations for grasping special objects. The functionality of the reconfigurable fingers enables the robotic gripper 1 of the present disclosure to swiftly adapt to the optimal configuration for handling a wide range of objects with different stiffness and geometries. Certainly, the present disclosure is not limited thereto and not redundantly described hereafter.

In summary, the present disclosure provides a robotic gripper with reconfigurable fingers for enhancing the adaptability and precision in object manipulation. The robotic gripper which is capable of adapting to a plurality of grasping configurations while ensuring that its cross-sectional area in the transverse plane is sufficiently compact for smart factory applications. The robotic gripper has for example one stationary finger and four reconfigurable fingers, which can re-position and re-orientate themselves. In order to maximize the motion range of each reconfigurable finger while concurrently minimizing their cross-sectional area in the transverse plane (x-y plane, refer to FIG. 2), the placements of the five fingers are divided into two layers with different heights (along the z-axis). Each reconfigurable finger is designed to be able to rotate ±75 degrees round the z-axis. Notably, the dimension of the robotic gripper along the z-axis is adjustable according to the practical requirements. Using the above design, the robotic gripper can potentially adapt to different configurations, making it suitable for handling objects with complex geometries and varying stiffness. Additionally, the robotic gripper is allowed to integrate various robotic fingers and soft tactile sensors, providing force and slip feedback during grasping operations. The robotic gripper with reconfigurable fingers offers distinct advantages in tasks that require high dexterity, adaptability, and precision. The robotic gripper with reconfigurable fingers closely mimics the human hand, allowing it to perform complex manipulation tasks such as pinching, holding, and grasping a wide range of objects. This makes the robotic gripper highly versatile for applications requiring precise control. With multiple reconfigurable fingers, the robotic gripper can adapt its shape to securely grasp objects of varying geometries, including irregular, soft, or delicate items. This capability is critical in industries like healthcare (e.g., handling medical instruments) and logistics (e.g., picking varied items). The plurality of reconfigurable fingers provide more contact points with the object, enhancing grip stability and control. This is particularly useful for tasks involving fragile or slippery items, where maintaining a secure hold is crucial.

At least four finger can be independently controlled and reconfigured, allowing the robotic gripper to switch between different grasping modes (e.g., precision grip, power grip). This flexibility makes the robotic gripper suitable for a broad spectrum of tasks without needing tool changes. The independent motion of each finger allows the robotic gripper to navigate and manipulate objects in tight or constrained environments, which is often challenging for traditional robotic hands. By spreading the grasping force across multiple fingers, the robotic gripper of the present disclosure reduces the risk of damaging delicate or sensitive objects, making it ideal for applications like food handling or electronics assembly. The human-like appearance and functionality of a five-finger robotic gripper make it more intuitive and safer for human-robot interaction, improving collaboration in shared workspaces. Even if one finger fails, the robotic gripper of the present disclosure can still function effectively, increasing reliability and fault tolerance during critical tasks. These advantages make the robotic gripper with reconfigurable fingers of the present disclosure particularly suited for advanced robotics applications where versatility, precision, and human-like manipulation are essential.

It will also be apparent to a skilled person that the embodiments described above are specific examples of a single broader invention, which may have greater scope than any of the singular descriptions taught. There may be many alterations made in the description without departing from the scope of the invention. While embodiments of the invention have been described, it is not intended that the invention be limited to said configuration disclosed thereto, as it is intended that the invention be as broad in scope as the art will allow and that the specification be read likewise not restrictive to the terminology described herein above. Any discussion of embodiments included in this specification is solely for the purpose of providing a context for the disclosure. It is not to be taken as an admission that any or all these matters form a part of the prior art base or were common general knowledge in the field relevant to the disclosure as it existed anywhere before the priority date of this application.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A robotic gripper with reconfigurable fingers, comprising:
a trunk extended in a vertical direction and comprising a first layer section and a second layer section arranged from top to bottom;
a first movable finger group comprising a first rotating support portion, a first bracket actuator, a first bracket, at least one first finger actuator, an extension rod and a first finger, wherein the first rotating support portion is arranged on the first layer section, and the first bracket actuator is arranged on the first rotating support portion, connected to the first bracket, and configured to drive the first bracket to rotate relative to the first rotating support portion, wherein the at least one first finger actuator and the extension rod are arranged on the first bracket and spatially corresponding to the first layer section and the second layer section, respectively, wherein the first finger is arranged at a bottom end of the extension rod, and the first finger is connected to the at least one first finger actuator through the extension rod and driven by the at least one first finger actuator; and
a second movable finger group comprising a second rotating support portion, a second bracket actuator, a second bracket, at least one second finger actuator and a second finger, wherein the second rotating support portion is arranged on the second layer section, and the second bracket actuator is arranged on the second rotating support portion, connected to the second bracket, and configured to drive the second bracket to rotate relative to the second rotating support portion, wherein the at least one second finger actuator is arranged on the second bracket and spatially corresponding to the second layer section, wherein the second finger is arranged at a bottom end of the second bracket, connected to the at least one second finger actuator, and driven by the at least one second finger actuator, wherein the first finger and the second finger are located at an identical horizontal height.

2. The robotic gripper with reconfigurable fingers according to claim 1, wherein the trunk comprises a top end fixed to a robot arm connection portion.

3. The robotic gripper with reconfigurable fingers according to claim 1, wherein the first movable finger group comprises at least one first insertion slot disposed at the bottom end of the extension rod and configured to connect the first finger.

4. The robotic gripper with reconfigurable fingers according to claim 3, wherein the second movable finger group comprises at least one second insertion slot disposed at the bottom end of the second bracket and configured to connect the second finger, wherein the at least one first insertion slot and the at least one second insertion slot are located at the identical horizontal height.

5. The robotic gripper with reconfigurable fingers according to claim 4, wherein the first bracket actuator controls the first bracket to rotate relative to the first rotating support portion within an angle range between −75 degrees and 75 degrees, and the second bracket actuator controls the second bracket to rotate relative to the second rotating support portion within an angle range between −75 degrees and 75 degrees.

6. The robotic gripper with reconfigurable fingers according to claim 5, wherein two of the first bracket actuators, two of the first brackets, two of the first finger actuators, two of the extension rods and two of the first fingers are arranged in pairs, and the two first brackets, the two of the first finger actuators, the two of the extension rods and the two of the first fingers are respectively arranged on two opposite lateral and outer sides of the second movable finger group.

7. The robotic gripper with reconfigurable fingers according to claim 6, wherein two of the second bracket actuators, two of the second brackets, two of the second finger actuators and two of the second fingers are arranged in pairs and disposed between the two extension rods and between the two first fingers.

8. The robotic gripper with reconfigurable fingers according to claim 1, further comprising at least one third finger actuator and a third finger, wherein the at least one third finger actuator is arranged on the second layer section of the trunk, and the third finger is arranged at a bottom end of the trunk, connected to the at least one third finger actuator, and driven by the at least one third finger actuator.

9. The robotic gripper with reconfigurable fingers according to claim 1, wherein the third finger, the first finger and the second finger are located at the identical horizontal height.

10. The robotic gripper with reconfigurable fingers according to claim 8, wherein each of the first finger, the second finger and the third finger comprises:
a plurality of finger segments, wherein the plurality of finger segments are pivotally connected in series from the base downward to a fingertip, wherein each of the plurality of finger segments comprises:
a body portion spatially corresponding to the fingertip and comprising a top surface and a bottom surface opposite to each other, and a first side and a second side opposite to each other, wherein the top surface and the bottom surface are connected through the first side and the second side, respectively;
an inner cavity recessed from the bottom surface of the body portion toward the top surface and located between the first side and the second side;
a first pivot hole passing the first side and the second side and in communication with the inner cavity;
an extruding portion disposed on the top surface, located between the first side and the second side, and spatially corresponding to the inner cavity;
a second pivot hole passing through the extruding portion and parallel to the first pivot hole; and
at least one cable hole passing through the top surface and the bottom surface, and misaligned with the extruding portion, the inner cavity and the first pivot hole;
wherein the extruding portion of a former one close to the fingertip is accommodated in the inner cavity of a latter one close to a fixed end of each adjacent two of the plurality of finger segments, and the first pivot hole of the former one is aligned with the second pivot hole of the latter one and pivotally connected via a pivot shaft, allowing the latter one to swing relative to the former one; and
an actuation cable connected to a corresponding one of the first finger actuator, the second finger actuator and the third finger actuator, and connected from the fixed end to the fingertip through the at least one cable hole of the plurality of finger segments in sequence, and then connected from the fingertip to the corresponding one of the first finger actuator, the second finger actuator and the third finger actuator through the at least one cable hole in sequence, wherein the corresponding one of the first finger actuator, the second finger actuator and the third finger actuator controls a tension of the actuation cable to control a posture and hardness of the corresponding one of the first finger, the second finger and the third finger.

11. The robotic gripper with reconfigurable fingers according to claim 10, wherein each of the plurality of finger segments comprises a protective skin, the protective skin comprises an upper opening and a lower opening, and the body portion is arranged on an outer periphery of the body portion through the upper opening and the lower opening.

12. The robotic gripper with reconfigurable fingers according to claim 11, wherein the protective skin comprises a stopper, which is respectively arranged adjacent to a periphery of the upper opening and a periphery of the lower opening, protruding from outside to inside, and abutting against the top surface and the bottom surface to fix the protective skin to the outer periphery of the body portion.

13. The robotic gripper with reconfigurable fingers according to claim 10, wherein each of the fingertips of the plurality of finger segments comprises a protective skin having an upper opening, the body portion passes through the upper opening so that the protective skin is arranged on an outer surface of the body portion.

14. The robotic gripper with reconfigurable fingers according to claim 13, wherein the protective skin includes a stopper, which is disposed adjacent to a periphery of the upper opening, protrudes from outside to inside, and abuts against the top surface to fix the protective skin to the outer surface of the body portion.

15. The robotic gripper with reconfigurable fingers according to claim 10, wherein each adjacent two of the plurality of finger segments has the former one close to the fingertip and the latter one close to the fixed end, the former one close to the fingertip is allowed to swing within an angle range relative to the latter one close to the base, and the angle range is between 120 degrees and −120 degrees.

16. The robotic gripper with reconfigurable fingers according to claim 10, wherein each of the plurality of finger segments further comprises a hollow structure penetrating the first side and the second side, in communication with the inner cavity, and arranged parallel to the first pivot hole.

17. The robotic gripper with reconfigurable fingers according to claim 10, wherein each of the first finger, the second finger and the third finger comprises at least one tactile sensor disposed at the fingertip and configured to sense pressure or sliding information of the first finger, the second finger and the third finger in contact with an object.

18. The robotic gripper with reconfigurable fingers according to claim 10, wherein each of the first finger actuator, the second finger actuator and the third finger actuator drives the actuation cable to change the tension through rotation.

19. The robotic gripper with reconfigurable fingers according to claim 1, wherein the first finger, the second finger and the third finger grasp an object by perform form closure and/or force closure.
